(19) United States
(12) Patent Application Publication
(10) Pub. No.: US 2013/0238523 A1
(43) Pub. Date: Sep. 12, 2013

(54) Apparatuses, Methods And Systems For Brokerage Fee Assessment And Management

(71) Applicant: Bal Agrawal, Chappaqua, NY (US)

(72) Inventor: Bal Agrawal, Chappaqua, NY (US)

(21) Appl. No.: 13/415,722

(22) Filed: Mar. 8, 2012

(51) Int. Cl. G06Q 40/00

(52) U.S. Cl. 705/36 R

(57) ABSTRACT

Disclosed are systems methods and apparatuses enabling variable brokerage fees on a transaction. In particular, a market value for a brokered service is determined based on various objective and subjective metrics. The brokerage service compares a calculated market value against the requested fee for the service to determine whether there is a differential. If there is a differential, value present in the differential can be used to adjust the brokerage fee up or down. Additional factors can be considered in determining the variable fee or differential include, the popularity of the brokered service, the location of the brokered service, particularized needs of a given client for the service, and the mix of providers to customers currently available to the brokerage. The disclosed system is particularly advantageous for determining brokerage fees for in-home service providers.

### FIELD OF THE INVENTION

The present invention is directed generally to apparatuses, methods, and systems for value-based brokerage arrangements. In particular, the invention pertains to the allocation of brokerage costs in a network-based brokerage service.

### BACKGROUND OF THE INVENTION

Interactive web based brokerage services, such as vacation home rental services, job board placement services and restaurant reservation services, often charge a fee to connect the two parties seeking each other, e.g., the merchant and consumer. Often, the fees are subscription based, item based, or dollar value of transaction based.

One of the most common brokerage arrangements is percentage based. For example, a summer home rental offered at $1000/week may have a fee that is 20 percent of the rent. The brokerage service charges the property owner or renter $200 for bringing the two parties together and executing the transaction.

Another common fee structure is subscription based. In a subscription-based system, a fee is paid based on the time the brokerage firm lists the service. For example, the candidate might pay $100 a week to have his service listed by the broker.

Another common fee structure is payment per contact, or item based. In this system, every time the broker connects a client with a service provider a fee is paid for the contact. The service provider or the client could pay this fee.

The above fee arrangements also apply, generally, home employment services such as nanny, housekeeper, dog walker, or personal chef search services. Specifically, most agencies and online service providers of search services have a fixed fee structure. For example, the traditional placement agency will charge a referral of 15% of the service provider's, e.g., nanny, annual salary.

### SUMMARY OF THE INVENTION

This disclosure details the implementation of methods, apparatuses, and systems that enable flexible fee assignment for a brokerage service. Typical brokerage services use a one-size-fits-all fee structure. In reality, however, the effort required on the part of the brokerage service can vary greatly from transaction to transaction. For example, one transaction might offer a service in high demand that is quickly fulfilled by the broker service, while another is difficult to place and requires a greater effort by the broker service. A one-size-fits-all fee structure, therefore, does not accurately capture the value provided by the brokerage service. Typically, however, the effort required to allocate fees on a case-by-case basis outweighed the benefit of adjusting the fees to capture the additional value.

Imperfect systems exist to attempt to solve the problem of allocating fees for a transaction. For example, in a typical real estate transaction the brokerage fee is charged as a percentage of the purchase price under the assumption that a more expensive property will take more effort to sell then a less expensive property. This assumption, however, is not true because it does not take into account whether the price requested for the property matches its perceived value. A relatively inexpensive house will still take a lot of effort to sell if its owner has priced it above the market price. On the other hand, an expensive house may sell quickly if its owner has priced it below the going market price.

Similar percentage based fee arrangements are also used in the placement of in home service providers. A traditional agency may, for example, charge a referral fee of 15% of the service provider's annual salary. These fee arrangements also do not necessarily accurately capture the value provided by the broker service.

This disclosure details systems and methods for evaluating information about the offered services that enable enhanced allocations of brokerage prices. The computer-based systems disclosed herein allow an efficient review of transaction details in order to facilitate fee allocation on a case-by-case basis.

In some embodiments, this disclosure addresses the fact that online brokerage services are sometimes unable to track the ultimate prices paid for a given transaction. In other words, if the online brokerage is simply connecting a customer and provider, but not processing the payments for the service rendered by the provider, it may not be able to determine the prices actually paid between two parties. In these cases, collecting a fee based on a percentage of the transaction is difficult. By allocating the fee according to the systems disclosed herein, a fair value based brokerage fee can be established without requiring the percentage based systems used in the past.

A particularly advantageous embodiment of the present system is a brokerage fee determining system capable of adjusting transaction fees on a case-by-case basis. The system has an input interface that receives provider information comprising experience information, location information, a quality evaluation and a requested fee for the provider's service. The system further contains storage to hold relevant information. An appraiser coupled to the input interface receives the provider information. The appraiser is further coupled to the storage to access provider information and generate provider appraisals. A value rater is also coupled to the appraiser. The value rater receives information from the appraiser, input interface and market price details from the storage to calculate a relative value differential. A fee calculator coupled to the value rater receives the relative value differential and is configured to compute a transaction fee based upon the relative value differential.

In another advantageous embodiment, a unique brokerage fee generation system is disclosed. The system has an input interface that receives provider information comprising experience information, location information, a quality evaluation and a requested fee and further receives client request information and client location information. The system also includes a provider information storage and market price information storage. A value differential analyzer is coupled to the input interface and includes two or more of the following: a quality analyzer that receives provider information from the input interface and creates a provider assessment and then compares the provider assessment to an average quality assessment; a ripeness evaluator that adjusts value based on how long it has been since the provider has been chosen by a client (the client selection being, for example, a request for further review of the provider or hiring the provider to provide the service; popularity evaluator that adjusts value based upon the amount of interest; a provider/client ratio adjustor that adjusts the value based upon the current ratio of providers to clients using the brokerage service; a client need evaluator that receives client request information from the input interface and adjusts the value based upon the client's needs (such as requirements and preferences); a travel time adjustment calculator that receives provider and client location information and adjusts value based on travel time. A fee adjustor coupled to the value differential analyzer and the market price information storage generating a fee adjustment. The fee adjustment representing the ultimate fee or being used to subtract from or add to the final fee. The fee adjustment determined based on two or more of the quality analyzer, ripeness evaluator, provider/client ratio, client need, or travel time adjustments.

Additional advantageous aspects of the disclosed embodiments are set forth in the detailed description.

### BRIEF DESCRIPTION OF THE DRAWINGS

The accompanying drawings illustrate various non-limiting, inventive aspects in accordance with the present disclosure:

FIG. 1 illustrates an overview of an embodiment of the disclosed systems.

FIG. 2 illustrates a system for fee calculation in accordance with an embodiment of the disclosed systems.

FIG. 3 illustrates an embodiment of a value differential analyzer in accordance with an embodiment of the disclosed systems.

FIG. 4 illustrates an embodiment of a quality analyzer in accordance with an embodiment of the disclosed systems.

FIG. 5 illustrates an embodiment of a brokerage service controller in accordance with an embodiment of the disclosed systems.

### DETAILED DESCRIPTION

In the following description of the various embodiments, reference is made to the accompanying drawings, which show by way of illustration various exemplary embodiments that practice the disclosed invention. It is to be understood that other embodiments may be utilized and structural and functional modifications may be made without departing from the scope of the present invention. Throughout this disclosure the brokered transactions are discussed as being between a service provider and a customer. This, however, should in no way be considered limiting on the invention. For example, instead of a service being brokered the transaction could involve an item being sold, leased or rented. Indeed, any transaction involving a broker fee or a finders' fee could potentially benefit from the inventions disclosed herein. Nonlimiting examples of possible brokered transactions include, job listings, real estate transactions, art sales, antique sales, nanny services, housekeeping services, chef services, restaurant reservations, and executive placement, matchmaking services. The disclosed systems, however, are particularly advantageous when used to broker transactions involving services or goods with prices that are highly variable based on numerous and/or subjective criteria.

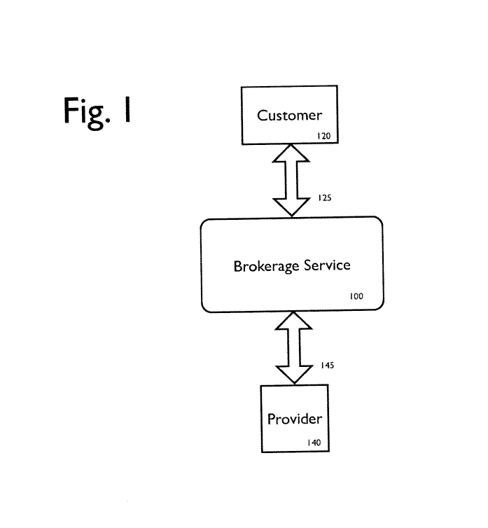

FIG. 1 shows the general structure of a system in accordance with the present disclosure, which can be implemented through software functions on a computer or networked group of computers as detailed throughout the application. A brokerage service 100 operates to accept service offers from provider 140. The service offers are then provided to customer 120. The brokerage service 100 attempts to connect customers, such as customer 120, with service providers.

Although only one provider 140 is shown, it is to be understood that many providers may list their services with the brokerage service 100. A communications link 145 allows provider 140 to transfer information to and from brokerage service 100. The communications link 145 can be embodied by any known communication system, such as telephone, in-person meetings, or network-based transactions, e.g., Web forms, proprietary gateways, e-mail submissions, mobile applications.

Although only one customer 120 is shown, is to be understood that many customers may use the brokerage service 100 to locate service providers. A communications link 125 allows the customer 120 transfer information to and from the brokerage service 100. Like communication link 145, communication link 125 can be embodied by any known communication medium. One particularly advantageous communication link between the customer and the brokerage service is a webpage that allows customers 120 browse numerous service providers 140 and select among them. Such a system, may allow a customer to choose a specific service provider and engage them to perform the requested service.

As will be described in detail below, operation of the brokerage service 100 involves the collection and storage of information about numerous providers, such as provider 140 and information about numerous transactions involving customers selecting specific providers. Data collected from these transactions, customer information, and service provider information is used by the brokerage service 100 in order to determine individual transaction-based fee arrangements. The operation may also involve storage of information about customers to record and evaluate their preferences.

The creation of individual transaction-based fee arrangements in accordance with the present disclosure can be accomplished in any of the prior fee styles. For example, in a system where the brokerage service receives a percentage of employees' yearly salary, the percentage charged for a particular transaction can be increased or decreased according to the value provided by the broker service.

In the case of a nanny service, an exemplary transaction may proceed as follows. Assume for example, that the typical nanny placement fee is 8 weeks compensation. For a nanny whose salary is $700 per week, the typical fee would be $5600. If in the case of this particular nanny based on her unique characteristics her market value was in fact 800 hundred dollars per week, there would be $100 per week in uncaptured value. This additional value can be captured, at least in part, by the brokerage service as follows. A typical nanny works for a family approximately 3 years. This would create a savings of $15,600 for the family hiring this particular nanny, when compared to the nanny's market rate based on her skill set. Using the value based calculation system in accordance with the present disclosure, the brokerage service could recognize this differential. The brokerage could then capture, for example, 5% of this value by increasing the fee charged for placing this particular nanny. Accordingly, the fee for the brokerage service would increase from $5600 to $6380. As will be detailed below, many factors can be used to determine the market value for this given nanny, such as skills, location, or personality. Moreover, the value of a particular nanny can differ from one employer to another. For example, the nanny may be fluent in a foreign language that is highly desired by one customer but irrelevant to the needs of another. In one embodiment, the disclosed system advantageously calculates the market value of a nanny for each individual employer-by-employee pair.

In another system, the brokerage fee may be charged as a flat rate per connection rather than a percentage of the provider customer transaction price. This system could work in any brokerage system, but would be particularly advantageous for systems based upon personal connections, such as dating services or employment search services. For example, on a dating site people looking to be connected with a potential date might pay a set fee, expressed in currency units or other tokens, each time they want to be connected with a particular person, e.g., it would cost 10 tokens to receive the contact information for person X. Using the system of the present disclosure would result in the fee amount, or number of tokens required, to be increased or decreased depending on the specific market value details of the person to whom the customers are being connected. And this value could be adjusted based upon particular pairs of contactors and contractees.

One exemplary token-based system would be a service to connect customers with home service providers, such as housekeepers or chefs. For this example assume that a typical charge for connecting a household with a housekeeper is 10 tokens. Further assume that a particular housekeeper, Sally, charges a rate of $20 per hour. If Sally's market rate, based on her level of skill, personality, and location, is $25 per hour, Sally's rate is 20% below the market rate. Accordingly, Sally would be in high demand from families seeking housekeepers and there would be a high value in connecting her with households. The value-based brokerage system could therefore charge more tokens to connect the family with Sally then it would charge for a typical housekeeper. For example, this system could increase its fee in tokens to 40% above the standard rate, i.e. double the 20% savings seen by the family. Accordingly, it would cost 14 tokens for the family to access Sally's details. Alternatively, the fee could be increased by some other amount, say 1 or 8 tokens, based on a pricing algorithm or system deemed suitable to the brokerage service.

Another potential system for use in a token-based, or fixed fee, system is to reduce the token fee by one token for every week a given service is offered without being selected by customer. In other words, if a particular provider, Amy, was difficult to place, her fee may start out at 10 tokens the 1st week and then be reduced one token the 2nd week. In this way, customers might be more inclined to take a chance on Amy because the fee associated with getting her contact information is lower than the upfront cost for a more highly prized candidate, such as Sally. In one embodiment, the weekly reduction in fees might not occur until some threshold has been met. For example, a service provider might have the standard fee applied for one month and then reduced on a weekly basis until that service provider is selected. In a further embodiment, service providers may be removed from the site if they receive no, or little, interest from clients after a certain amount of time. Participants can also be removed if they are non-responsive (e.g., users who do not respond promptly to contact requests). This advantageously avoids cluttering the site with unpopular and non-responsive candidates. As discussed in below, this concept of reducing fee due to time decay can be combined with other aspects of the disclosed systems to arrive at an adjusted fee.

In the first example involving Sally, the brokerage service reaped the benefit of the difference between the rate charged by Sally and the expected market rate by increasing the brokerage fee. In the alternative, the brokerage service might choose to reduce its brokerage fee for people such as Sally because they take fewer resources to place. In the example involving Amy, the brokerage service reduced its fee in order to improve the chances that a transaction will be completed. In the alternative, a brokerage service may choose to increase the brokerage fee charged for placing Amy because increased resources are required to complete the transaction. The direction of the fee up or down may be dependent on who is paying the fee, the provider or the customer. The direction and amount of the brokerage fee adjustment can be chosen by the brokerage fee service as needed to suit its business goals. In other words, the systems and methods disclosed herein are not primarily directed to increasing brokerage fees. Instead, they are directed to systems to provide a flexible means to evaluate brokerage fee pricing and set it based on that information.

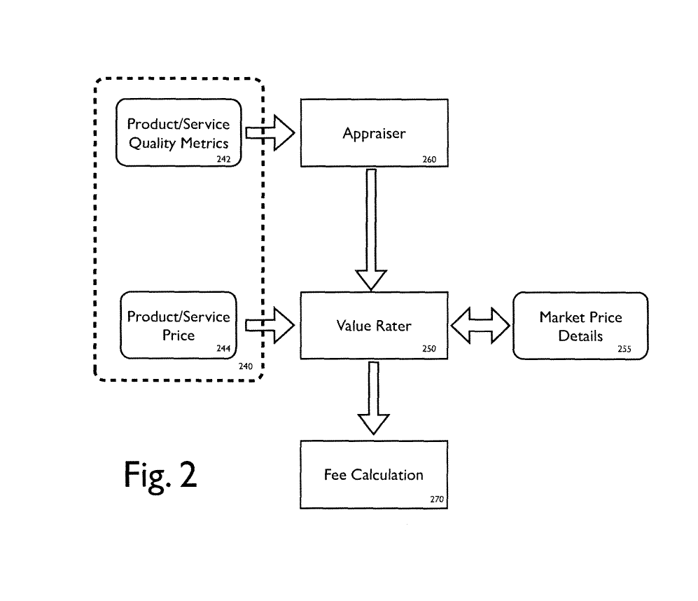

FIG. 2 shows an exemplary embodiment of a value based fee structure setting system, which can be advantageously implemented with software running on a computer or a group of networked computers. In order to provide some context, the operation of the FIG. 2 embodiment will be discussed with respect to a representative problem of placing a nanny with a family requesting nanny services. However, as with respect to the other disclosed embodiments, the system would be similarly applicable to other types of brokered services.

The fee setting system of FIG. 2 receives provider specific information 240. The provider specific information includes Service Quality Metrics 242. The Service Quality Metrics can include objective or subjective information about the service provider. A Nanny's Service Quality Metrics, for example, might include years of experience, languages spoken, first aid certifications, educational level, evaluations from an in person interview, recommendations from prior employers, etc. The Service Quality Metrics can be obtained from a number of sources. For example, the Brokerage Service can input them or the Service Provider can input them. The Service Quality Metrics can also come from third party sources.

The Service Quality Metrics 242 are received by Appraiser 260. The Appraiser uses the Service Quality Metrics in order to determine the market value of the Service Provider's service. This process involves synthesizing the information about the service provider into a quality rating that can be used to compare the Service Provider to other service providers available in the market. Advantageously, this information can be derived from the Brokerage Service's history of transactions for similar service providers. This information can also be updated and improved over time as new transactions are completed and recorded.

For Example, a Nanny Quality matrix may have four equal parts, consisting of background, experience, personality and skills. Each of these high level parts may have sub-parts. For example the background consisting or driving record, criminal record and credit report. Skills may include six specific measures. Such as communication, care, swimming, teaching, activity, and knowledge of psychology of early childhood development.

As shown in FIG. 2, the rating from the Appraiser 260 is passed to the Value Rater 250. The Value Rater then retrieves Market Price Details 255 for similar service providers. The Value Rater also receives the Service Provider's Service Price 244. The Value Rater uses this information to calculate a value differential that represents the difference between the price requested and the market value of the service provider's services. In its simplest form, the value differential is simply the average market price for similarly rated service providers minus the price requested by the service provider. That only works optimally, however, if there are sufficient numbers of similarly rated service providers to create the average value. Note, because service providers are not commodities, the system might have a minimum differential threshold before it considers the difference great enough to cause a fee adjustment. For example, it might ignore differences +/−5% or +/−10%.

One advantageous embodiment of the present disclosure uses a weighted average to determine the value differential. This operates most advantageously when Appraiser 260 specifies the quality rating as a structured value, such as number. Assuming, similar numeric ratings have been calculated for the other service providers, the market values can be compared in price per quality units (e.g., price divided by quality rating). The price per quality value can be calculated for each market participant. When these values are averaged over all market participants the average price per quality value calculated for all market participants can be used to determine the value differential for service provider at issue.

As shown in the FIG. 2 embodiment, the value differential is passed to the Fee Calculation unit 270 for the calculation of the actual fee for the particular service provider at issue. The fee for the brokerage service could be adjusted to capture some or the entire value differential when the differential is significant. In addition to the value differential, the fee can also be adjusted based on other factors, such as proximity between service provider and customer, elapsed time since the offer was posted, or number of requests for connection already received.

The fee can be adjusted based on the travel distance for the service provider from the customer. For example, if the travel distance is more than 30 minutes between a particular provider/customer pair, the broker fee is lowered for each 15 minutes of additional travel time. For example, for 30 to 45 minutes of travel time the introduction or placement fee can be lowered by 20 percent. For the next block of travel time, 45 minutes to an hour, the fee can be lowered by 40 percent. The particular details of the adjustments can be made to suit the market at issue. For example, rural areas might include less travel time reduction than urban areas because the expected amount of travel time in rural markets is typically longer. Reducing fees for travel time is particularly advantageous for brokerages working with home service providers, such as housekeepers, personal trainers or nannies, and where the broker fee is for introductions rather than consummated transactions. Longer travel distances make it less likely that the parties will consummate their transaction because of the time and expense needed to travel to and from work. Reducing the connection fee recognizes the reduction in the likelihood of the connection paying off.

The fee can be also adjusted based on the time since the offer was posted, as discussed above. For example, if the customer pays the brokerage fee, it might be reduced periodically until a connection is made. This recognizes that fact that customers see less value in a particular provider. Alternatively, if the service provider pays the brokerage fee, the price of the fee might go up periodically until a connection is made. This recognizes that the service provider was using more of the brokerage's resources to make a connection.

The fee can be adjusted based on the number of requests for connection received. For example, if the consumer is paying the fee, the brokerage fee can go up to take into account the popularity of a particular provider. On the other hand, if the service provider pays the brokerage fee, the fee can go down to reflect the fact that brokerage service is receiving a high volume of requests for connection because the provider is enhancing the value of the brokerage service by generating so much interest.

A particularly advantageous embodiment of the present invention involves considering all of the above features in adjusting the fee received by the brokerage service because it allows maximum flexibility in efficient matching. For example, the fee adjustment can be calculated as:

Value Differential=f(quality differential)+f(travel time)+f(time posted)+f(existing requests)+f(client need)+f(client provider ratio)

Fee Adjustment=f(Value Differential*Market Cost)

Fee=Standard Fee+Fee Adjustment

Briefly, the value differential is a number representing the value of this particular provider/customer pairing relative to an average pairing. A function, f ( ) of the value differential times the average market price for the transaction at issue is used to determine the fee adjustment for this transaction. The final fee is then calculated as the standard fee plus or minus the fee adjustment.

More specifically, the value differential is calculated as functions of a number of different parameters. These functions may be different for each term and can perform scaling to normalize the various terms into suitable ranges. In addition to normalization, the functions can also be used to scale the various terms relative to one another to suit the valuation opinions of the brokerage service, e.g., increasing or decreasing the affect of the terms, such as travel time or client/provider ratio.

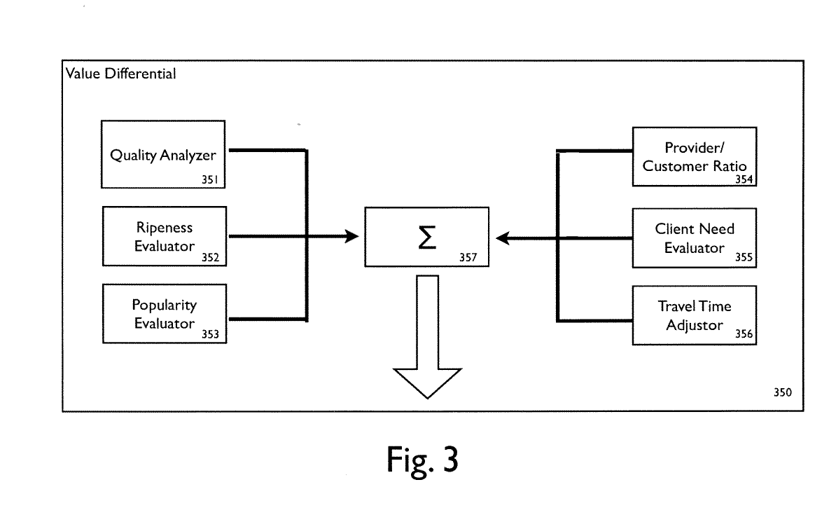

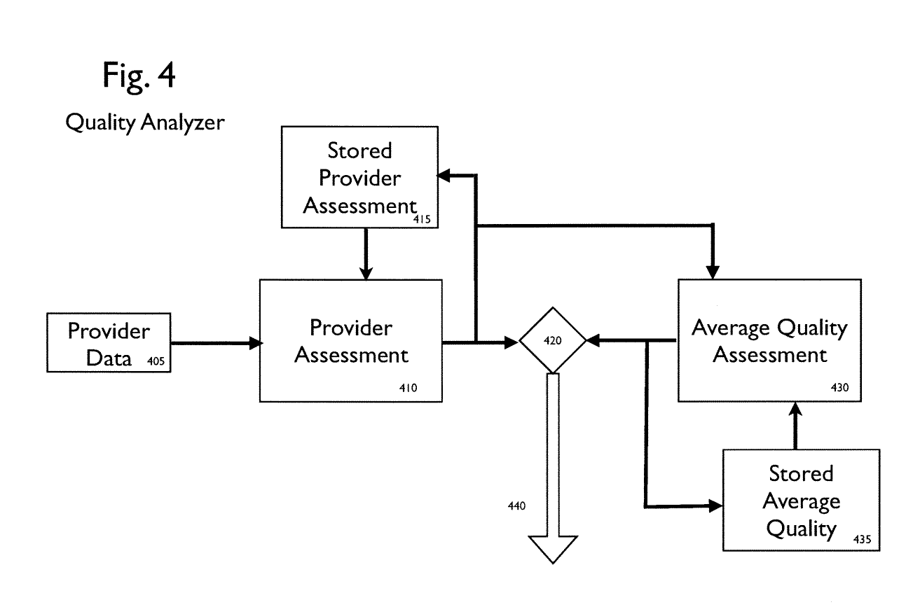

The structure of an embodiment of the value differential calculator is shown in FIG. 3, which can advantageously be implemented with software running on a computer or a group of networked computers. The value differential calculator comprises a quality analyzer 351, discussed in further detail with regard to FIG. 4. While six parameters are shown, parameters could be removed, added, combined or altered in other advantageous embodiments as needed to suit the designers of a particular embodiment of the brokerage service.

The value differential calculator also comprises a ripeness evaluator 352, which is a function that accounts for length of time since the provider has offered its service without any interest. For example, the value differential can be decreased for every week that the provider's listing is provided without interest.

The value differential calculator also comprises a popularity evaluator 353, which is a function that increases when the provider receives a lot of interest, e.g., requests for contacts, or has a history of receiving a lot of interest.

The value differential calculator also comprises provider/customer ratio 354, which is a function based upon the current ratio of providers to customers using the brokerage service. For example, if a 3 to 1 ratio of customers to providers is typical for a given area, the provider/customer ratio function generator can increase or decrease the value differential if the current actual customer/provider ratio is above or below 3 to 1. In this way, lower or higher fees can promote a return to the optimal 3 to 1 ratio.

The value differential calculator also comprises client need evaluator 355, which is a function that adjusts the value differential based on needs of the client. For example, if a customer has an urgent need or needs assistance at an unusual time, e.g., a holiday, the client need evaluator can increase its value. The client need evaluator can also increase or decrease depending upon how closely the provider meets the client's preferences. For example, if the client has specified 10 criteria in an ideal provider, the value differential can go up for a provider that has closer to all 10 criteria or it can go down for a provider that has fewer of the specified criteria.

The value differential calculator also comprises a travel time adjustor 356, which is a function that adjusts the value differential based on the travel distance between the provider and the client. For example, the travel time adjuster may reduce the value differential for providers that are nearby the client. On the other hand, the value differential may be increased for providers that are over a certain distance from the client.

An exemplary embodiment of the quality analyzer 351 is shown in FIG. 4, which can advantageously be implemented in software running on a computer or group of networked computers. The quality analyzer comprises a provider assessment analyzer 410 in an average quality assessment generator 430. The results from the provider assessment 410 in the average quality assessment 430 are supplied to comparator 420. The output of the comparator 440 is a value representing the differential between the provider's quality and the average quality of similar providers.

The provider assessment analyzer 410 receives input comprising provider data 405 and stored provider assessment data 415, if any. The perceived provider data comprises any relevant information for the type of service provider being assessed. For example, a nanny's provider data may include resume type formation, references from previous employers, subjective analyses from the brokerage service provider or third parties. The provider assessment analyzer uses this information to evaluate how this particular provider compares to other providers of the same service in the marketplace. In making this analysis, the system may have information on file regarding the particular provider, such as the results of prior assessment or previously recorded provider data 405 from a prior assessment. In this way, the provider assessment analyzer can continually update it assessment of the provider. For example, if the provider works for a client, feedback regarding the provider's performance can be supplied to the system to update the provider evaluation. As shown in FIG. 4, the output of the provider assessment analyzer is fed back to the stored provider assessment for later use.

The provider analysis is also provided to the average quality assessment generator 430 in order to update the data comprising the average provider quality in the market place. This update could occur before or after the average quality assessment is provided to comparator 420. Whenever the calculations are made, the results of this updated assessment are fed back to the stored average quality records 435 in order to improve the data available to the system.

To make the average quality assessment the generator 430 receives information about relevant providers from the stored average quality records 435. This could be a pre-computed value or the actual underlying data necessary to calculate the current average quality assessment, or some combination thereof.

The particular data used, metrics assigned, and equations used will vary based on the type of market at issue, e.g., nannies, housekeepers, dating services, etc. Furthermore, these values will depend upon the subjective opinions of the service provider. Accordingly, any equations can be used in accordance with the knowledge and judgment of persons of skill in the art without departing from the systems disclosed herein. In particularly advantageous embodiments of the present inventions, the systems disclosed allow this information to be calculated for every provider client pair and the brokerage fee adjusted accordingly.

In a further embodiment the adjusted value and the fee adjustment can be exposed to the client. In particular, when the value adjustment causes the brokerage fee to be increased, that information can be passed along to the client. This would let the client know that they are getting a good deal on the client service for the cost of a minor increase in the price of the brokerage fee. Furthermore, the brokerage fee increase could be split into two parts, one paid immediately and the other paid after increased value of the provider is demonstrated.

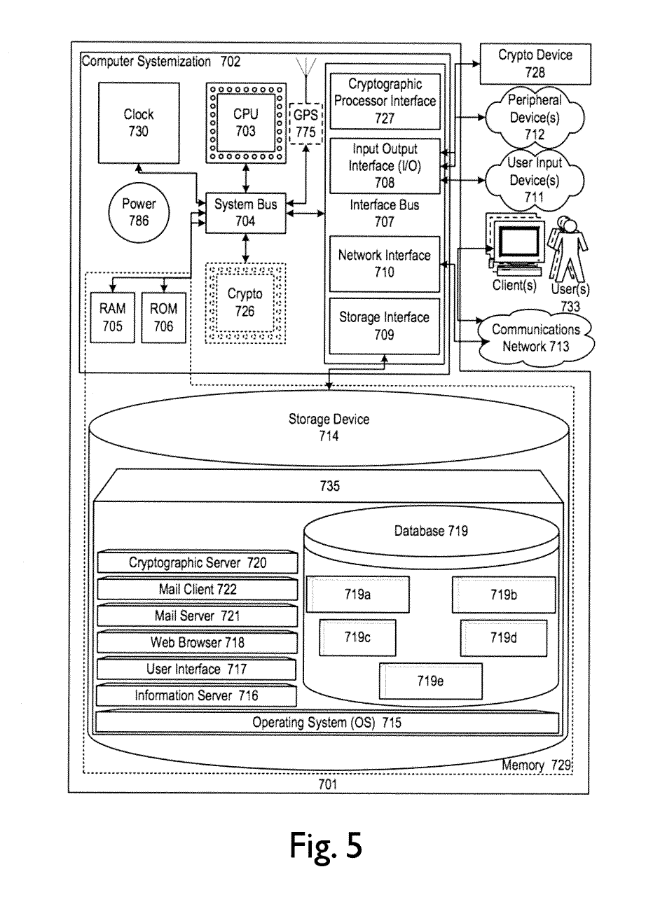

A particularly advantageous embodiment of the present invention is obtained by using a brokerage service controller to embody the various features described above. FIG. 5 illustrates inventive aspects of an brokerage service controller 701 in a block diagram. In this embodiment, the brokerage service controller 701 may serve to accept, retrieve, store, search, serve, submit, identify, transmit, instruct, generate, match, and/or update databases containing relevant information and/or service provider information and/or related data.

Typically, users, which may be people and/or other systems, engage information technology systems (e.g., commonly computers) to facilitate information processing. In turn, computers employ processors to process information; such processors are often referred to as central processing units (CPU). A common form of processor is referred to as a microprocessor. A computer operating system, which, typically, is software executed by CPU on a computer, enables and facilitates users to access and operate computer information technology and resources. Common resources employed in information technology systems include: input and output mechanisms through which data may pass into and out of a computer; memory storage into which data may be saved; and processors by which information may be processed. Often information technology systems are used to collect data for later retrieval, analysis, and manipulation, commonly, which is facilitated through database software. Information technology systems provide interfaces that allow users to access and operate various system components.

In one embodiment, the brokerage service controller 701 may be connected to and/or communicate with entities such as, but not limited to: one or more users from user input devices 711; peripheral devices 712; and/or a communications network 713.

Networks are commonly thought to comprise the interconnection and interoperation of clients, servers, and intermediary nodes in a graph topology. It should be noted that the term “server” as used throughout this disclosure refers generally to a computer, other device, software, or combination thereof that processes and responds to the requests of remote users across a communications network. Servers serve their information to requesting “clients.” The term “client” as used herein refers generally to a computer, other device, software, or combination thereof that is capable of processing and making requests and obtaining and processing any responses from servers across a communications network. A computer, other device, software, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The brokerage service controller 701 may be based on common computer systems that may comprise, but are not limited to, components such as: a computer systemization 702 connected to memory 729.

Computer Systemization

A computer systemization 702 may comprise a clock 730, central processing unit (CPU) 703, a read only memory (ROM) 706, a random access memory (RAM) 705, and/or an interface bus 707, and most frequently, although not necessarily, are all interconnected and/or communicating through a system bus 704. Optionally, the computer systemization may be connected to an internal power source 786. Optionally, a cryptographic processor 726 may be connected to the system bus. The system clock typically has a crystal oscillator and provides a base signal. The clock is typically coupled to the system bus and various clock multipliers that will increase or decrease the base operating frequency for other components interconnected in the computer systemization. The clock and various components in a computer systemization drive signals embodying information throughout the system. Such transmission and reception of signals embodying information throughout a computer systemization may be commonly referred to as communications. These communicative signals may further be transmitted, received, and the cause of return and/or reply signal communications beyond the instant computer systemization to: communications networks, input devices, other computer systemizations, peripheral devices, and/or the like. Of course, any of the above components may be connected directly to one another, connected to the CPU, and/or organized in numerous variations employed as exemplified by various computer systems.

The CPU comprises at least one high-speed data processor adequate to execute program modules for executing user and/or system-generated requests. The CPU may be a microprocessor such as AMD's Athlon, Duron and/or Opteron; ARM based processor; IBM and/or Motorola's PowerPC; Intel's Celeron, Itanium, Pentium, Xeon, Core and/or XScale; and/or the like processor(s). The CPU interacts with memory through signal passing through conductive conduits to execute stored program code according to conventional data processing techniques. Such signal passing facilitates communication within the brokerage service controller and beyond through various interfaces. Should processing requirements dictate a greater amount speed, parallel, mainframe and/or super-computer architectures may similarly be employed. Alternatively, should deployment requirements dictate greater portability, smaller tablet, smart phone or Personal Digital Assistants (PDAs) may be employed.

Power Source

The power source 786 may be of any standard form for powering small electronic circuit board devices such as the following power cells: alkaline, lithium hydride, lithium ion, nickel cadmium, solar cells, and/or the like. Other types of AC or DC power sources may be used as well. In the case of solar cells, in one embodiment, the case provides an aperture through which the solar cell may capture photonic energy. The power cell 786 is connected to at least one of the interconnected subsequent components of the brokerage service controller thereby providing an electric current to all subsequent components. In one example, the power source 786 is connected to the system bus component 704. In an alternative embodiment, an outside power source 786 is provided through a connection across the I/O 708 interface. For example, a USB and/or IEEE 1394 connection carries both data and power across the connection and is therefore a suitable source of power.

Interface Adapters

Interface bus(ses) 707 may accept, connect, and/or communicate to a number of interface adapters, conventionally although not necessarily in the form of adapter cards, such as but not limited to: input output interfaces (I/O) 708, storage interfaces 709, network interfaces 710, and/or the like. Optionally, cryptographic processor interfaces 727 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 709 may accept, communicate, and/or connect to a number of storage devices such as, but not limited to: storage devices 714, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 710 may accept, communicate, and/or connect to a communications network 713. Through a communications network 713, the brokerage service controller is accessible through remote clients 733b (e.g., computers with web browsers) by users 733a. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 710 may be used to engage with various communications network types 713. For example, multiple network interfaces may be employed to allow for the communication over broadcast, multicast, and/or unicast networks.

Input Output interfaces (I/O) 708 may accept, communicate, and/or connect to user input devices 711, peripheral devices 712, cryptographic processor devices 728, and/or the like. I/O may employ connection protocols such as, but not limited to: light peak, thunderbolt, Apple Desktop Bus (ADB); Apple Desktop Connector (ADC); audio: analog, digital, monaural, RCA, stereo, and/or the like; IEEE 1394a-b; infrared; joystick; keyboard; midi; optical; PC AT; PS/2; parallel; radio; serial; USB; video interface: BNC, coaxial, composite, digital, Digital Visual Interface (DVI), RCA, RF antennae, S-Video, VGA, and/or the like; wireless; and/or the like. A common output device is a television set, which accepts signals from a video interface. Also, a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Typically, the video interface provides the composited video information through a video connection interface that accepts a video display interface (e.g., an RCA composite video connector accepting an RCA composite video cable; a DVI connector accepting a DVI display cable, etc.).

User input devices 711 may be card readers, dongles, finger print readers, gloves, graphics tablets, joysticks, keyboards, mouse (mice), remote controls, retina readers, trackballs, trackpads, and/or the like.

Peripheral devices 712 may be connected and/or communicate to I/O and/or other facilities of the like such as network interfaces, storage interfaces, and/or the like. Peripheral devices may be audio devices, cameras, dongles (e.g., for copy protection, ensuring secure transactions with a digital signature, and/or the like), external processors (for added functionality), goggles, microphones, monitors, network interfaces, printers, scanners, storage devices, video devices, video sources, visors, and/or the like.

It should be noted that although user input devices and peripheral devices may be employed, the brokerage service controller may be embodied as an embedded, dedicated, and/or monitor-less (i.e., headless) device, wherein access would be provided over a network interface connection.

Memory

Generally, any mechanization and/or embodiment allowing a processor to affect the storage and/or retrieval of information is regarded as memory 729. However, memory is a fungible technology and resource, thus, any number of memory embodiments may be employed in lieu of or in concert with one another. It is to be understood that the brokerage service controller and/or a computer systemization may employ various forms of memory 729. For example, a computer systemization may be configured wherein the functionality of on-chip CPU memory (e.g., registers), RAM, ROM, and any other storage devices are provided by a paper punch tape or paper punch card mechanism; of course such an embodiment would result in an extremely slow rate of operation. In a typical configuration, memory 729 will include ROM 706, RAM 705, and a storage device 714. A storage device 714 may be any conventional computer system storage. Storage devices may include a drum; a (fixed and/or removable) magnetic disk drive; a magneto-optical drive; an optical drive (i.e., CD ROM/RAM/Recordable (R), ReWritable (RW), DVD R/RW, etc.); and/or other devices of the like. Thus, a computer systemization generally requires and makes use of memory.

Module Collection

The memory 729 may contain a collection of program and/or database modules and/or data such as, but not limited to: operating system module(s) 715 (operating system); information server module(s) 716 (information server); user interface module(s) 717 (user interface); Web browser module(s) 718 (Web browser); database(s) 719; cryptographic server module(s) 720 (cryptographic server); the brokerage service module(s) 735; and/or the like (i.e., collectively a module collection). These modules may be stored and accessed from the storage devices and/or from storage devices accessible through an interface bus. Although non-conventional software modules such as those in the module collection, typically, are stored in a local storage device 714, they may also be loaded and/or stored in memory such as: peripheral devices, RAM, remote storage facilities through a communications network, ROM, various forms of memory, and/or the like.

Operating System

The operating system module 715 is executable program code facilitating the operation of the brokerage service controller. Typically, the operating system facilitates access of I/O, network interfaces, peripheral devices, storage devices, and/or the like. The operating system may be a highly fault tolerant, scalable, and secure system such as Apple Macintosh OS X (Server), AT&T Plan 9, Be OS, Linux, Unix, and/or the like operating systems. However, more limited and/or less secure operating systems also may be employed such as Apple Macintosh OS, Microsoft DOS, Palm OS, Windows 2000/2003/3.1/95/98/CE/Millenium/NT/XP (Server), and/or the like. An operating system may communicate to and/or with other modules in a module collection, including itself, and/or the like. Most frequently, the operating system communicates with other program modules, user interfaces, and/or the like. For example, the operating system may contain, communicate, generate, obtain, and/or provide program module, system, user, and/or data communications, requests, and/or responses. The operating system, once executed by the CPU, may enable the interaction with communications networks, data, I/O, peripheral devices, program modules, memory, user input devices, and/or the like. The operating system may provide communications protocols that allow the brokerage service controller to communicate with other entities through a communications network 713. Various communication protocols may be used by the brokerage service controller as a subcarrier transport mechanism for interaction, such as, but not limited to: multicast, TCP/IP, UDP, unicast, and/or the like.

Information Server

An information server module 716 is stored program code that is executed by the CPU. The information server may be a conventional Internet information server such as, but not limited to Apache Software Foundation's Apache, Microsoft's Internet Information Server, and/or the. The information server may allow for the execution of program modules through facilities such as Active Server Page (ASP), ActiveX, (ANSI) (Objective-) C (++), C#, Common Gateway Interface (CGI) scripts, Java, JavaScript, Practical Extraction Report Language (PERL), Python, WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), and/or the like. The information server provides results in the form of Web pages to Web browsers, and allows for the manipulated generation of the Web pages through interaction with other program modules. After a Domain Name System (DNS) resolution portion of an HTTP request is resolved to a particular information server, the information server resolves requests for information at specified locations on the brokerage service controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other modules in a module collection, including itself, and/or facilities of the like. Most frequently, the information server communicates with the brokerage service controller, operating systems, other program modules, user interfaces, Web browsers, and/or the like.

Also, an information server may contain, communicate, generate, obtain, and/or provide program module, system, user, and/or data communications, requests, and/or responses.

User Interface

The function of computer interfaces in some respects is similar to automobile operation interfaces. Automobile operation interface elements such as steering wheels, gearshifts, and speedometers facilitate the access, operation, and display of automobile resources, functionality, and status. Computer interaction interface elements such as check boxes, cursors, menus, scrollers, and windows (collectively and commonly referred to as widgets) similarly facilitate the access, operation, and display of data and computer hardware and operating system resources, functionality, and status. Operation interfaces are commonly called user interfaces. Graphical user interfaces (GUIs) such as the Apple Macintosh Operating System's Aqua, iOS, Microsoft's Windows XP, or Unix's X-Windows provide a baseline and means of accessing and displaying information graphically to users.

A user interface module 717 is stored program code that is executed by the CPU. The user interface may be a conventional graphic user interface as provided by, with, and/or atop operating systems and/or operating environments such as Apple Macintosh OS, e.g., Aqua, Microsoft Windows (NT/XP), Unix X Windows (KDE, Gnome, and/or the like), mythTV, and/or the like. The user interface may allow for the display, execution, interaction, manipulation, and/or operation of program modules and/or system facilities through textual and/or graphical facilities. The user interface provides a facility through which users may affect, interact, and/or operate a computer system. A user interface may communicate to and/or with other modules in a module collection, including itself, and/or facilities of the like. Most frequently, the user interface communicates with operating systems, other program modules, and/or the like. The user interface may contain, communicate, generate, obtain, and/or provide program module, system, user, and/or data communications, requests, and/or responses.

Web Browser

A Web browser module 718 is stored program code that is executed by the CPU. The Web browser may be a conventional hypertext viewing application such as Firefox, Chrome, Safari, Microsoft Internet Explorer or Netscape Navigator. Secure Web browsing may be supplied with 128 bit (or greater) encryption by way of HTTPS, SSL, and/or the like. Some Web browsers allow for the execution of program modules through facilities such as Java, JavaScript, ActiveX, and/or the like. Web browsers and like information access tools may be integrated into PDAs, cellular telephones, and/or other mobile devices. A Web browser may communicate to and/or with other modules in a module collection, including itself, and/or facilities of the like. Most frequently, the Web browser communicates with information servers, operating systems, integrated program modules (e.g., plug-ins), and/or the like; e.g., it may contain, communicate, generate, obtain, and/or provide program module, system, user, and/or data communications, requests, and/or responses. Of course, in place of a Web browser and information server, a combined application may be developed to perform similar functions of both. The combined application would similarly affect the obtaining and the provision of information to users, user agents, and/or the like from the brokerage service enabled nodes. The combined application may be nugatory on systems employing standard Web browsers.

Brokerage Service Controller Module

The brokerage service controller module 735 is stored program code that is executed by the CPU. The brokerage service controller module affects accessing, obtaining and the provision of brokerage service, and/or the like across various communications networks.

The brokerage service controller module enabling access of information between nodes may be developed by employing standard development tools such as, but not limited to: (ANSI) (Objective-) C (++), Apache modules, binary executables, database adapters, Java, JavaScript, mapping tools, procedural and object oriented development tools, PERL, Python, shell scripts, SQL commands, web application server extensions, WebObjects, and/or the like. The brokerage service controller module may communicate to and/or with other modules in a module collection, including itself, and/or facilities of the like. Most frequently, the brokerage service controller module communicates with a brokerage service database containing the data required to be stored by the system, operating systems, other program modules, and/or the like. The brokerage service controller module may contain, communicate, generate, obtain, and/or provide program module, system, user, and/or data communications, requests, and/or responses.

Distributed Brokerage Service Controller Module

The structure and/or operation of any of the brokerage service controller components may be combined, consolidated, and/or distributed in any number of ways to facilitate development and/or deployment. Similarly, the module collection may be combined in any number of ways to facilitate deployment and/or development. To accomplish this, one may integrate the components into a common code base or in a facility that can dynamically load the components on demand in an integrated fashion.

The module collection may be consolidated and/or distributed in countless variations through standard data processing and/or development techniques. Multiple instances of any one of the program modules in the program module collection may be instantiated on a single node, and/or across numerous nodes to improve performance through load-balancing and/or data-processing techniques. Furthermore, single instances may also be distributed across multiple controllers and/or storage devices; e.g., databases. All program module instances and controllers working in concert may do so through standard data processing communication techniques.

The configuration of the brokerage service controller will depend on the context of system deployment. Factors such as, but not limited to, the budget, capacity, location, and/or use of the underlying hardware resources may affect deployment requirements and configuration. Regardless of if the configuration results in more consolidated and/or integrated program modules, results in a more distributed series of program modules, and/or results in some combination between a consolidated and distributed configuration, data may be communicated, obtained, and/or provided. Instances of modules consolidated into a common code base from the program module collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If module collection components are discrete, separate, and/or external to one another, then communicating, obtaining, and/or providing data with and/or to other module components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), process pipes, shared files, and/or the like. Messages sent between discrete module components for inter-application communication or within memory spaces of a singular module for intra-application communication may be facilitated through the creation and parsing of a grammar. A grammar may be developed by using standard development tools such as lex, yacc, XML, and/or the like, which allow for grammar generation and parsing functionality, which in turn may form the basis of communication messages within and between modules. Again, the configuration will depend upon the context of system deployment.

The entirety of this disclosure (including the Cover Page, Title, Headings, Field, Background, Summary, Brief Description of the Drawings, Detailed Description, Claims, Abstract, Figures, and otherwise) shows by way of illustration various embodiments in which the claimed inventions may be practiced. The advantages and features of the disclosure are of a representative sample of embodiments only, and are not exhaustive and/or exclusive. They are presented only to assist in understanding and teach the claimed principles. It should be understood that they are not representative of all claimed inventions. As such, certain aspects of the disclosure have not been discussed herein. That alternate embodiments may not have been presented for a specific portion of the invention or that further undescribed alternate embodiments may be available for a portion is not to be considered a disclaimer of those alternate embodiments. It will be appreciated that many of those undescribed embodiments incorporate the same principles of the invention and others are equivalent. Thus, it is to be understood that other embodiments may be utilized and functional, logical, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program modules (a module collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the invention, and inapplicable to others. In addition, the disclosure includes other inventions not presently claimed. Applicant reserves all rights in those presently unclaimed inventions including the right to claim such inventions, file additional applications, continuations, continuations in part, divisions, and/or the like thereof. As such, it should be understood that advantages, embodiments, examples, functional, features, logical, organizational, structural, topological, and/or other aspects of the disclosure are not to be considered limitations on the disclosure as defined by the claims or limitations on equivalents to the claims.

1. A brokerage fee determining system capable of adjusting transaction fees on a case-by-case basis comprising:
a processor and a communications interface;
an input interface running on the processor and configured to receive provider information associated with a first provider via the communications interface; wherein the provider information includes provider experience information, provider location information, a provider quality evaluation and a requested provider fee;
an appraiser coupled to the input interface and configured to use one or more pieces of the provider information to generate provider appraisals reflecting a provider quality rating for the first provider;
a value rater coupled to the appraiser to receive the quality rating and coupled to the input interface to receive at least the requested provider fee and further configured to calculate a relative value differential for the first provider based on market price detail information; and
a fee calculator coupled to the value rater to receive the relative value differential and configured to compute a transaction fee based upon the relative value differential.

2. The system of claim 1 wherein the appraiser is coupled to the input interface via a storage.

3. The system of claim 2 wherein the appraiser is configured to store the provider appraisal in the storage.

4. The system of claim 3 further comprising a market rate calculator configured to use the provider appraisal and provider requested fee to update the market pricing data.

5. The system of claim 1 wherein the appraiser uses two or more of the elements of provider information to create the provider quality rating.

6. The system of claim 1 wherein the fee calculator only adjusts the fee relative to a standard fee if the relative value differential is plus or minus 5% of the standard fee.

7. A unique brokerage fee generation system comprising:
an input interface, wherein the input interface receives provider information including experience information, location information, a quality evaluation and a requested fee, wherein the input interface further receives client request information and client location information;
a provider information storage;
a market price information storage;
a value differential analyzer coupled to the input interface including:
a quality analyzer, wherein the quality analyzer receives provider information from the input interface and creates a provider assessment and the provider assessment is compared to an average quality assessment;
a client need evaluator, wherein the client need evaluator receives the client request information from the input interface;
a travel time adjustment calculator, wherein the travel time adjustment calculator receives provider location information and client location information; and
the value differential analyzer further including one or more of the following:
a ripeness evaluator;
a popularity evaluator;
a provider/customer ratio adjustor;
a fee adjustor coupled to the value differential analyzer and the market price information storage to generate a fee adjustment.

8. A unique brokerage fee generation system comprising:
an input means for receiving provider info nation including experience, location, a quality evaluation and a requested fee, and for further receiving client request information and client location information;
a provider information storage;
a market price information storage;
a value differential analyzer coupled to the input interface including:
a quality analyzer means for receiving provider information from the input interface, creating a provider assessment, and comparing the provider assessment to an average quality assessment;
a client need evaluator means for receiving the client request information from the input interface and comparing the client request information to the provider information;
a travel time adjustment calculator means for receiving provider location information and client location information; and
the value differential analyzer further including one or more of the following:
a ripeness evaluator means for adjusting the value differential based on provider ripeness;
a popularity evaluator means for adjusting the value differential based on provider popularity;
a provider/customer ratio adjustor means for adjusting the value differential based on a current ratio of providers to customers;
a fee adjustor means coupled to the value differential analyzer and the market price information storage for creating a fee adjustment.

9. The unique brokerage fee generation system of claim 8, wherein the fee adjustment leads to an increased fee when the value differential indicates that the provider is undervalued.

10. The unique brokerage fee generation system of claim 8, wherein the value differential analyzer includes each of the ripeness evaluator means, popularity evaluator means and provider/customer ratio adjustor means.

11. A method for determining a brokerage fee on a case-by-case basis on a computerized system having a processor and a communications interface comprising:
receiving provider information associated with a first provider via the communications interface; wherein the provider information includes provider experience information, provider location information, a provider quality evaluation and a requested provider fee;
generating provider appraisals reflecting a provider quality rating for the first provider;
calculating a relative value differential for the first provider based on market price detail information; and
computing a transaction fee based upon the relative value differential.

12. The method claim 11 further comprising using the provider appraisal and provider requested fee to update the market pricing data.

13. The method of claim 11 wherein the generating uses two or more of the elements of provider information to create the provider quality rating.
